(19) United States
(12) Patent Application Publication
(10) Pub. No.: US 2026/0146920 A1
(43) Pub. Date: May 28, 2026

(54) VEHICLE TEST STAND AND METHOD FOR CARRYING OUT MEASUREMENT AND ADJUSTMENT WORK ON A VEHICLE AND FOR CARRYING OUT DRIVING SIMULATIONS USING THE VEHICLE TEST STAND

(71) Applicant: DÜRR ASSEMBLY PRODUCTS GMBH, Püttlingen (DE)

(72) Inventors: Ismail Kurt, Völklingen (DE); Timo Wallscheid, Schmelz (DE); Thomas Engel, Schwalbach (DE); Marc Ney, Saarlouis (DE)

(21) Appl. No.: 19/123,467

(22) PCT Filed: Sep. 25, 2023
(86) PCT No.: PCT/DE2023/100709

§ 371 Date: Apr. 23, 2025

(30) Foreign Application Priority Data
Oct. 24, 2022 (DE) 10 2022 127 982.0

(51) Int. Cl. G01M 17/04

(52) U.S. Cl. CPC G01M 17/045

(57) ABSTRACT

The invention relates to a vehicle test stand (1) with wheel receiving areas (201, 202, 203, 204; 301; 501) for the wheels of a vehicle to be tested. Each of the wheel receiving areas (201, 202, 203, 204; 301; 501) has a respective support device (306; 502) attached to one or two respective rollers (302, 303) on which the wheels of the vehicle to be tested stand. At least one of the rollers (303) of one wheel receiving area (201, 202, 203, 204; 301; 502) is paired with a drive and/or loading unit (209, 210, 211, 212; 305; 505, 506). In a first operating state of the wheel receiving areas (201, 202, 203, 204; 301; 501), each support device (306, 502) is rotatably mounted about a vertical axis. In the first operating state of the wheel receiving areas (201, 202, 203, 204; 301; 501), the support device (306; 502) is supported so as to freely rotate such that the support device (306; 502) can be rotated as a result of forces transmitted from the vehicle wheels standing on the rollers to the rollers (302, 303). According to the invention, at least some parts of the drive and/or loading units (209, 210, 211, 212; 305; 506) can be mechanically coupled and uncoupled (308, 309) to and from each roller (303). At least the parts of the drive and/or loading units (209, 210, 211, 212; 305; 506) which can be coupled and uncoupled are not arranged on the respective support device (306; 502).

### RELATED APPLICATIONS

This application is a national phase of International Application No. PCT/DE 2023/100709, filed on Sep. 25, 2023, which claims the benefit of German Application No. 10 2022 127 982.0, filed on Oct. 24, 2022. The foregoing International Application, and German Application are incorporated herein by reference in their entireties and for all purposes.

### FIELD OF THE DISCLOSURE

The disclosure relates to a vehicle test stand, and a method for carrying out measurement and adjustment work on a vehicle and for carrying out driving simulations using such a vehicle test stand.

The subject matter is a vehicle test stand having wheel receptacles for the wheels of a vehicle to be tested.

### BACKGROUND

The vehicle test stand is designed in such a way that there is in each case one wheel receptacle present for each wheel or each wheel combination on each side of an axle. If the vehicle has twin wheels on one or a plurality of axles, these pairs of wheels bear in each case on a common wheel receptacle. In the context discussed, these twin wheels are wheel combinations.

### SUMMARY

The wheel receptacles can be designed as so-called apex rollers. In this instance, the wheel receptacle has one roller. The respective wheel bears on the apex line of the roller. Here, there are usually also so-called holding rollers which in front and behind the respective wheel of the vehicle rest on this wheel in order to hold the wheel on the apex line of the apex roller without the wheel slipping off.

The wheel receptacles can also be embodied as so-called double rollers. When the wheel receptacle is designed having the double roller, the respective wheel of the vehicle drops between these two rollers in such a way that the wheel bears on both rollers. The depth to which the wheel drops depends on the spacing of the two rollers, on the diameter of the rollers, and on the diameter of the wheel.

A vehicle test stand of this type is already known (DE 10 2015 115 607 A1). The wheel receptacles of the vehicle test stand described in that document have rollers on which the wheels of the vehicle to be tested bear. These rollers are rotatable about a vertical axis (perpendicular to the longitudinal axes of the rollers). As a result, forces from the rollers of the wheel receptacle can be directed onto the respective wheels of the vehicle in that the rollers of the wheel receptacle are rotatable by means of a driving element. In this context, this does not mean that the rollers are set in rotation about their longitudinal axis. Instead, this means in this context that the rollers situated in the horizontal plane are rotated in such a way that the orientation of the longitudinal axis of the respective roller in the horizontal plane changes. As a result, it is possible to direct forces onto the vehicle wheel by changing the position of the longitudinal axis of the rollers of the wheel receptacle in relation to the respective wheel axis of the wheel bearing thereon. There is a clutch by way of which the driving element can be engaged or disengaged.

Other types of wheel receptacles, in the form of what are known as floating plates, are also known. These have an operating state in which these floating plates are in low-friction mountings so that the floating plates in the event of a change of the steering angle of the wheel bearing thereon can follow these changes in the steering angle. These floating plates are used for adjustment work of the parameters of the suspension geometry (toe angle and camber angle of the wheels of the vehicle). When the adjusting means of the vehicle for the toe angle and camber angle are activated this, in terms of the toe angle, leads to a rotation of the wheel which would likewise take place if a corresponding steering angle of the wheel were to be adjusted by way of the steering wheel at the adjusted toe angle of the wheel. This type of floating plate is used for the adjustment work of the parameters of the suspension geometry, because the floating plate follows the changes in the toe angle during the adjustment work in such a way that no mechanical stresses arise between the rollers of the wheel receptacle and the wheel bearing thereon.

The drive and/or load units are connected in a form-fitting and/or force-fitting manner to at least one roller of the wheel receptacle so as to direct forces onto this roller. The drive and/or load unit can be designed with a drive by way of which the respective roller of the wheel receptacle is driven in the context of a rotation about the longitudinal axis of said roller, or is decelerated counter to the drive or load momentums which are directed from the wheel of the vehicle onto the respective roller. Additionally or alternatively to this drive, it is also possible to couple an inert mass to the roller (load unit) in such a way that the moment of inertia of the roller is increased when the load unit is coupled thereto.

The wheel receptacles presently have in each case one support device. One or two rollers are in each case attached to the support device (depending on whether the wheel receptacle is designed with an apex roller or with double rollers). The wheels of the vehicle to be tested bear on these rollers in the manner described.

At least one of the rollers of a wheel receptacle is assigned a drive and/or load unit.

The first operating state is the operating state of the floating plate in which the latter is mounted so as to be freely rotatable.

In this operating state, measurement and adjustment work of the parameters of the suspension geometry (toe angle and camber angle of the wheels) can be performed. In this operating state, the rollers of the wheel receptacle, owing to the rotation about the vertical axis, follow the changes in the orientation of the wheel axis of the respective bearing wheel when carrying out the adjustment work of the parameters of the suspension geometry.

In the first operating state of the wheel receptacles, the respective support device is mounted so as to be rotatable about a vertical axis in such a manner that in this first operating state of the wheel receptacle the support device is mounted so as to be freely rotating. The support device is thus rotatable owing to forces which are transmitted from the bearing wheels of the vehicle to the rollers.

In this way, the wheel receptacle that is used in vehicle test stands in which driving simulations are carried out is enhanced in terms of its functionality in such a way that adjustment work on the parameters of the suspension geometry can also be carried out in this vehicle test stand.

It is already known from the prior art (de 10 2004 001 439 A1 and EP 2 677 293 B1) to embody a vehicle test stand in such a way that in a first operating state measurement and adjustment work of the parameters of the suspension geometry can be carried out by way of this vehicle test stand, whereby driving simulations can be carried out in a second operating state. Present for this purpose are drive units for the rollers of the wheel receptacles, by way of which in the second operating state forces which act on the respective wheel of the vehicle can be introduced by driving or decelerating the rollers in terms of a rotation about the longitudinal axis of the latter. In the first operating state, the rollers of the wheel receptacles are mounted in such a way that these rollers in terms of a rotation about a vertical axis can follow the rotation of the wheels in the sense of a steering angle of the wheels when this steering angle changes when carrying out the adjustment work. In the process, the drive units remain connected to the rollers of the wheel receptacles to the extent that these drive units are conjointly rotated when the respective roller rotates about the vertical axis.

Examples disclosed herein are based on the object of enhancing the potential for use of the vehicle test stand.

According to examples disclosed herein, at least parts of the drive and/or load units are able to be mechanically coupled to and decoupled from the respective roller.

In the design embodiment of the vehicle test stand according to examples disclosed herein, at least the couplable and decouplable parts of the drive and/or load units are moreover not disposed on the respective support device.

The couplable and decouplable parts of the drive and/or load units are able to be mechanically coupled to and decoupled from the respective roller.

This coupling and decoupling goes beyond the engagement and disengagement of the clutch of the drive and/or load unit in the vehicle test stand according to the prior art. The drive and/or load unit remains mechanically connected to the respective roller during engagement and disengagement of the clutch. A separation by way of the clutch takes place only to the extent that there is no longer a force-fit between an output of the drive unit and the load unit in terms of the rotation of the roller about the longitudinal axis thereof. The same applies in an analogous manner when an electric motor as the drive unit is de-energized.

The mechanical coupling and decoupling according to examples disclosed herein means that a separation takes place to the extent that when mechanically decoupling the couplable and decouplable parts of the drive and/or load unit in relation to the roller, these represent a separate component (or a plurality of separate components) in relation to the roller which no longer has (have) any connection to the roller. In particular, when decoupling the couplable and decouplable parts of the drive and/or load unit, these parts are thus also decoupled in terms of a rotation of the respective roller (and thus also of the other roller of the wheel receptacle and the support device) about the vertical axis.

It is thus advantageous in this design embodiment that the couplable and decouplable parts of the drive and/or load unit
owing to the possibility of being mechanically decoupled from the roller; and
owing to the fact that the drive and/or load unit is not attached to the support device,

in this decoupled state do not have to be conjointly rotated during a rotation of the support device. The moment of inertia in terms of a rotation of the support device about the vertical axis is thus reduced. p This is particularly advantageous for carrying out adjustment work of the parameters of the suspension geometry. In this adjustment work, the adjusting means on the vehicle are activated in such a way that the parameters of the suspension geometry of the individual wheels change. It is advantageous when no mechanical stresses arise in the suspension and/or the wheels.

For this reason, the respective wheel receptacle of the wheel on which adjustment work is performed is in the first operating state. For the avoidance of the mechanical stresses it is important that the wheel receptacle is mounted with as little friction as possible so that the support device owing to the forces introduced from the wheel (in particular during a change of the adjustment of the toe angle) follows this change of the toe angle by way of a highly dynamic rotation. This low-friction mounting (meaning negligible in the balance of forces) leads to the adjustment of the orientation of the longitudinal axis of the roller of the wheel receptacle to the toe angle of the wheel taking place in such a way that no lasting deviations between the orientation of the longitudinal axis of the roller of the wheel receptacle in relation to the toe angle of the wheel arise because frictional forces of the mounting of the wheel receptacle are included in the balance of forces.

For the avoidance of mechanical stresses in the suspension of the vehicle it is also expedient that this “following” of the orientation of the longitudinal axis of the roller(s) of the wheel receptacle for changing the orientation of the wheel axis of the wheel bearing thereon takes place as fast as possible.

In order to avoid these mechanical stresses as effectively as possible it has proven advantageous to pay attention not only that the wheel receptacle (support device) at the end of the adjustment procedure reaches in each case the position in which the orientation of the longitudinal axes of the rollers correlate with the toe angle of the bearing wheel. It has proven expedient for the dynamics of the rotating movement of the support device to be conceived in such a way that the orientation of the longitudinal axes of the rollers follow the change of the respective toe angle as fast as possible.

In this context, the design embodiment is advantageous in which the couplable and decouplable parts of the drive and/or load unit are not assembled on the support device and can be mechanically decoupled from the respective roller. In this decoupled state, the couplable and decouplable parts of the drive and/or load unit do not contribute to the moment of inertia which influences the dynamics of the rotating movement of the wheel receptacle with the support device about the vertical axis in the first operating state. In this first operating state of the wheel receptacle, this moment of inertia is reduced by the mechanical decoupling of the couplable and decouplable parts of the drive and/or load unit, so that the orientation of the rollers of the wheel receptacles in this first operating state follows a change of the respective toe angle by way of very positive dynamics.

In the design embodiment as claimed in claim 1, the connection of the couplable and decouplable parts of the drive and/or load units to the respective roller of the wheel receptacle during the mechanical coupling of the drive and/or load units to the respective roller is furthermore embodied in such a way that this connection follows a rotation of the longitudinal axis of the respective roller about the vertical axis. Alternatively or additionally to this design embodiment of the connection of the couplable and decouplable parts of the drive and/or load units to the respective roller, the drive and/or load units in the vehicle test stand can be movable in the horizontal plane in such a way that the longitudinal axis of the connection of the drive and/or load units to the respective roller follows the change of the orientation of the longitudinal axis of the respective roller during a rotation of the support device about the vertical axis.

The mechanical coupling and decoupling can refer to the drive and/or load units overall, or only to parts of the drive and/or load unit. If only parts of the drive and/or load unit are able to be mechanically coupled and decoupled, this can be expedient when the respective roller is to be connected to a drive unit as well as to a load unit. The respective roller is driven or decelerated in its rotation about the longitudinal axis relative to the rotation of the bearing wheel by way of the drive unit, the latter being an electric motor, for example. The load unit is a centrifugal mass by which the moment of inertia of the respective roller is increased in terms of a rotation about the longitudinal axis of the latter. The moment of inertia of the load unit also requires that the latter has a large mass. If the drive and/or load unit is then not to be completely mechanically couplable and decouplable, but rather only parts of the drive and/or load unit, it proves to be an expedient design embodiment in this context to design the load unit so as to be mechanically couplable and decouplable in the sense described here, while the drive unit remains mechanically coupled to the respective roller. The drive unit can then be decoupled in the first operating state. The decoupling can be implemented in that a clutch is present, by way of which the drive train between the drive unit and the respective roller is able to be separated, or-in the case of an electric motor in that the electric motor is separated from the electrical power supply to the extent that the electric motor is current-free and voltage-free so that the rotor of the electric motor rotates conjointly with the roller when the latter rotates about its longitudinal axis. In the case described here, the “housing” of the drive train of the drive unit remains connected to the respective roller.

It is also within the scope of examples disclosed herein that the drive and/or load unit can also be completely mechanically couplable to and decouplable from the respective roller.

This first operating state of the wheel receptacles has to be distinguished from the operating state in which the support devices of the wheel receptacles are not mounted so as to freely rotate but are stationary in terms of the rotation about a vertical axis, or are rotated in a targeted manner by way of driving means so as to direct forces onto the respective wheel of the vehicle by way of this rotation. With the design embodiment of the targeted rotation of the wheel receptacle, the vehicle can be positioned in the lateral direction in the vehicle test stand. In this way, negotiation of curves can also be simulated.

The support device is mounted so as to be rotatable about a vertical axis.

The rollers (which are attached to the support device) can also be rotated in the same sense as a result of the rotation of the support device. In this context, this does not mean that the rollers can rotate about their longitudinal axis. This rotatability means that the rollers are rotatable about the vertical axis, i.e. perpendicularly to the longitudinal axis of the rollers.

It s advantageously derived by integrating wheel receptacles having the functional scope of claim 1 into a vehicle test stand, that measurement and adjustment work of parameters of the suspension geometry (toe angle; camber angle of the wheels of the vehicle) can be performed, as well as driving situations of the vehicle (for example braking procedures with rotating wheels, or else more complex driving situations of the vehicle with accelerations and also negotiation of curves if the wheel receptacles are rotatable by driving means) being able to be simulated, by using such a vehicle test stand.

For carrying out the simulation Of the driving situations, drive and/or load units of at least one of the rollers are assigned to a wheel receptacle.

Furthermore, at least parts of the drive and/or load units are able to be mechanically coupled to and decoupled from the respective roller.

In contrast to the known prior art, the drive and/or load unit is thus not only separated by a clutch in terms of the force-fit, or as an electric motor switched to be free of a current and a voltage, but in the decoupled state is to this extent completely mechanically separated from the respective roller and mechanically reconnected to the latter during coupling.

In the design embodiment of the vehicle test stand as claimed in claim 2, in the first operating state of the wheel receptacle the couplable and decouplable parts of the respective drive and/or load unit are mechanically decoupled.

This is associated with the advantage that the masses to be moved are reduced. This applies in particular also to the moment of inertia.

In the design embodiment of the vehicle test stand as claimed in claim 3, in the second operating state of the wheel receptacles for carrying out driving simulations of the vehicle the drive and/or load units are completely mechanically coupled. At best as a function of specific driving situations, the couplable and decouplable parts of the drive and/or load units are mechanically decoupled.

This is associated with the advantage that driving resistances can be simulated by way of the coupled drive and/or load units (optionally also circumstances that cause an acceleration of the vehicle such as, for example, downhill driving). The roller f the wheel receptacle that is connected to the drive and/or load unit is correspondingly accelerated or decelerated by the drive and/or load unit. The moment of inertia of the roller can be increased by coupling a load unit thereto.

In the second operating state, the drive and/or load units are in principle coupled to the respective rollers of the wheel receptacles. Described in the context of claim 6 is a driving situation in which it is expedient to decouple the couplable and decouplable pars of the drive and/or load units during an ongoing driving situation.

Claim 4 relates to a vehicle test stand in which in the second operating state of the wheel receptacles the support device is rotatable about at least one vertical axis by driving means in such a way that, owing to the rotation of the respective support device, forces are transmitted by way of the at least one roller of the wheel receptacle to the bearing wheel of the vehicle to be tested.

In such a design embodiment of the vehicle test stand, it is also possible to position the vehicle laterally in the vehicle test stand, or else to simulate the negotiation of curves, by a corresponding rotation of the wheel receptacle.

In the design embodiment of the vehicle test stand as claimed in claim 5, parts of the driving means in the first operating state of the respective wheel receptacle are mechanically decoupled from the support device.

As a result, the moments of inertia which counteract a rotation of the support device of the respective wheel receptacle about the vertical axis can advantageously be reduced yet again when in the first operating state forces from the respective wheel of the vehicle are directed onto the rollers of the wheel receptacle.

In the design embodiment of a vehicle test stand as claimed in claim 6, in the second operating state of the wheel receptacles the couplable and decouplable parts of the drive and/or load units when carrying out driving simulations are mechanically decoupled at least when the specific driving situation consists of the vehicle being braked by a braking force which is above a defined threshold value.

In completely coupled drive and/or load units, the reactive forces during braking procedures at a high braking force can lead to the vehicle being lifted out of the wheel receptacles. This can lead to damage to the vehicle. Moreover, more or less uncontrolled movements of this type of the vehicle can represent a safety hazard.

It has therefore proven advantageous in intense braking procedures of this type to mechanically decouple the couplable and decouplable parts of the drive and/or load units. This leads to the forces counteracting the braking forces of the vehicle being significantly reduced. In completely decoupled drive and/or load units, only the comparatively minor moments of inertia of the rollers in conjunction with the frictional forces between the respective bearing wheel and the respective roller counteract the braking moment of the vehicle. This leads to the rollers being brought correspondingly quickly to the rotating speed “0”, so that no reactive forces in relation to the braking forces of the vehicle then act on the vehicle. When the drive and/or load units are not completely mechanically decoupled, but only parts of the drive and/or load units, this nevertheless advantageously leads to a reduction of the moments of inertia and, optionally, driving forces which by way of the rollers counteract the braking procedure of the vehicle.

By decoupling the couplable and decouplable parts of the drive and/or load units in intense braking procedures it can thus be avoided that the wheels of the vehicle are lifted out of the wheel receptacles of the vehicle test stand during a braking procedure.

If the connection of the couplable and decouplable parts of the drive and/or load units to the respective roller of the wheel receptacle during the mechanical coupling of the drive and/or load units to the respective roller is embodied in such a way that this connection follows a rotation of the longitudinal axis of the respective roller about the vertical axis, this can take place as claimed in claim 7, for example, in that a homokinetic articulated shaft is a constituent part of this connection.

If the drive and/or load units in the vehicle test stand are movable in the horizontal plane in such a way that the longitudinal axis of the connection of the drive and/or load units to the respective roller follows the change of the orientation of the longitudinal axis of the respective roller during a rotation of the support device about the vertical axis, this applies in any case to the parts of the drive and/or load units that are not mechanically couplable and decouplable, provided that these parts that are not couplable and decouplable are attached to the support device. These parts rotate conjointly with a rotation of the support device about the vertical axis.

In the case of parts of the drive and/or load units that are not attached to the support device, the longitudinal axis of the connection of these parts of the drive and/or load units to the respective roller can follow the change of the orientation of the longitudinal axis of the respective roller during a rotation of the support device about the vertical axis in that these parts of the drive and/or load units that are not attached to the support device are movable in the horizontal plane in the direction of the X-coordinate (longitudinal axis c a vehicle standing in the vehicle test stand) and the Y-coordinate (transverse direction in the horizontal plane relative to the longitudinal axis of a vehicle standing in the vehicle test stand). This displaceability in the X-and Y-direction can furthermore be combined with the fact that the connection is embodied by a homokinetic articulated shaft. Owing to this fact, it can be taken into account that the orientation of the longitudinal axis of the roller of the wheel receptacle in the vehicle test stand changes when the support device (and thus also the roller of the wheel receptacle) £ is rotated. Alternatively or additionally to the embodiment of the connection with a homokinetic articulated shaft, the parts of the drive and/or load units that are not attached to the respective support device can also be mounted in such a way that these parts of the drive and/or load units are displaceable in the horizontal plane not only in the X-and Y-direction but are additionally also rotatable in such a way that the orientation of the connection of these parts of the drive and/or load units to the respective roller is adapted to the orientation of the longitudinal axis of the respective roller. The corresponding parts of the drive and/or load units that are not attached to the respective support device can be attached to a support which is in a first position aligned in such a way that the connection of these parts of the drive and/or load units is oriented in the same direction as the longitudinal axis of the respective roller. The support of the drive and/or load unit can then in each case be guided in the sense of a positive guide on a circular line in the horizontal plane, which is concentric with the intersection point between the horizontal plane and the vertical axis about which the support device is rotatable. The vertical axis herein advantageously also intersects the longitudinal axis of the respective roller to which the couplable and decouplable parts of the drive and/or load units are coupled or couplable, respectively. In this way, the parts of the drive and/or load unit that are not attached to the support device can be moved in such a way that they are displaceable in the X-and Y-direction and are in the process simultaneously rotated in such a way that the orientation of the connection of the corresponding parts of the drive and/or load unit corresponds to the orientation of the longitudinal axis of the roller. Advantageously, this connection can have a homokinetic articulated shaft as a constituent part. In this way, mechanical stresses can be absorbed, which can be created because the drive and/or load unit follows the rotating movement of the support device. As a result of this “tracking” there is a (minor) temporal delay, so that the mechanical stresses created thereby can be compensated by the homokinetic articulated shaft.

In the design embodiment of the vehicle test stand as claimed in claim 7, a homokinetic articulated shaft is a constituent part of the connection of the couplable and decouplable parts of the drive and/or load unit during the mechanical coupling of the couplable and decouplable parts of the drive and/or load units to the respective roller.

In the design embodiment of the vehicle test stand as claimed in claim 8, the mechanical coupling and decoupling of the couplable and decouplable parts of the drive and/or load unit to and from the respective roller takes place by means of a coupling member which is a Hirth serration.

In the design embodiment of the vehicle test stand as claimed in claim 9, the vehicle test stand is assigned a vehicle conveyor system. By means of this vehicle conveyor system it is possible for the vehicle to be tested to be conveyed in an automated manner into the vehicle test stand and for said vehicle to then be placed in such a way that the wheels of the vehicle bear on the wheel receptacles of the vehicle test stand.

In this state, the measurement and adjustment work and the test procedures can be carried out on the vehicle. Upon completion thereof, the vehicle can be received by the vehicle conveyor system again, and then be conveyed out of the vehicle test stand.

Claim 10 relates to a method for carrying out measurement and adjustment work on a vehicle, and for carrying out a vehicle test using a vehicle test stand as claimed in one of claims 1 to 10. In the case of a vehicle of which the wheels bear on the wheel receptacles of the vehicle test stand, the method comprises the following steps:
(i) carrying out measurement and adjustment work of parameters of the suspension geometry, wherein the respective wheel receptacles in the process are in the first operating state;

and
(ii) simulating driving conditions for the vehicle to be tested, wherein the wheel receptacles in the process are in the second operating state.

This method describes the procedure for carrying out the adjustment work of the parameters of 41 the suspension geometry, and for carrying out driving simulations on a test stand of which the wheel receptacles, corresponding to the design embodiments of claims 1 to 6, are specified for carrying out the two measures according to steps (i) and (ii). It can be seen that the designations (i) and (ii) are simply indicators which identify an enumeration. This does not establish any sequence of these two steps. It is also possible to first carry out driving simulations in the vehicle test stand, and to subsequently perform the adjustment work of the parameters of the suspension geometry. The sequence in which step (ii) follows step (i) has however the advantage that the parameters of the suspension geometry have already been finalized when carrying out the driving simulations.

In the method as claimed in claim 10, the reference to claim 9 means that the two steps (i) and (ii) are carried out on a vehicle which has been conveyed into the vehicle test stand and has been placed therein in such a way that the wheels of the vehicle bear on the wheel receptacles of the vehicle test stand. Upon carrying out the two steps (i) and (ii), the vehicle is in this case received by the vehicle conveyor system again and conveyed out of the vehicle test stand.

Claim 11 relates to a method using a vehicle test stand with a vehicle conveyor system. In the vehicle test stand, the wheel receptacles have in each case double rollers. The wheel receptacles of the vehicle test stand have lifting means having a first operating position for lifting the wheels of the vehicle in relation to a second operating position of the lifting means, in which the wheels of the vehicle are in the position dropped between the two rollers of the wheel receptacles when carrying out simulated driving of the vehicle. Receiving the vehicle by the vehicle conveyor system herein takes place so as to be synchronized with the adjustment of the lifting means to the first operating position of the latter.

The lifting means can be lifting bars which will be explained hereunder in the context of FIG. 3. The lifting means can also consist of the fact that the spacing of the longitudinal axes of the two rollers of a wheel receptacle is adjustable so as to be variable in the horizontal plane. When the spacing of the longitudinal axes of the two rollers is set to the minimum, the wheel of the vehicle is correspondingly dropped to the minimum between the two rollers. If the spacing of the longitudinal axes of the two rollers is adjusted to be larger, the wheel drops correspondingly deeper. The spacing between the longitudinal axes of the rollers can thus be used as a lifting means. The minimum spacing of the rollers then corresponds to the first operating position of the lifting means. When the rollers are adjusted in such a way that their longitudinal axes have a larger spacing, this corresponds to the second operating position. The minimum spacing between the longitudinal axes of the rollers is defined by the radius of the rollers and is at least the sum of the radii of the two rollers—neglecting any construction-related constraints.

Synchronizing the adjustment of the first operating position of the lifting means and the receiving of the vehicle for the outward conveyance proves advantageous to the extent that receiving the vehicle by the vehicle conveyor system takes place when the wheels of the vehicle are no longer dropped between the rollers of the wheel receptacles in order to carry out measurement and adjustment work of the parameters of the suspension geometry, or to simulate driving of the vehicle.

If it has been described in the context of the preceding explanations that the mechanical coupling and decoupling of the drive and/or load units is to take place as a function of specific operating conditions (for example, braking the vehicle by a braking force above a threshold value), the mechanical decoupling can take place in an automated manner in that the corresponding operating conditions are identified by a control unit. In the event of the corresponding operating conditions, the control unit acts by way of actuating means on those members by way of which the drive and/or load unit is mechanically coupled and decoupled.

Switching between the first and the second operating state can also take place as a function of a request signal being entered, indicating that measurement and adjustment work of the parameters of the suspension geometry are to be carried out. In response to this request signal, the wheel receptacles can be switched to the first operating state (optionally successively in order to stabilize the position and orientation of the vehicle by way of the wheel receptacles, the latter then not being in the first operating state). When a confirmation signal is entered, indicating that the measurement and adjustment work of the parameters of the suspension geometry is completed, the wheel receptacles can be switched to the second operating state in order to carry out driving simulations. Mechanical decoupling of the drive and/or load units during driving simulations can then take place again as a function of identified operating conditions.

### BRIEF DESCRIPTION OF THE DRAWINGS

An exemplary embodiment of examples disclosed herein is illustrated in the drawing in which:

FIG. 1: shows a vehicle test stand with a vehicle conveyor system;

FIG. 2: shows the vehicle test stand according to FIG. 1 without the vehicle conveyor system;

FIG. 3: shows a wheel receptacle having double rollers and a drive and/or load unit which is assigned to one of the two rollers of the wheel receptacle;

FIG. 4: shows the wheel receptacle according to FIG. 3 without the drive and/or load unit;

FIG. 5: shows a perspective view (top view) of a wheel receptacle in which an exemplary embodiment of a rotation of the support device (support plate) about a vertical axis is illustrated, wherein the rotation is performed by a motorized drive;

FIG. 6: shows a view of the wheel receptacle from FIG. 5 from below; and

FIG. 7: shows an alternative construction for mechanically coupling and decoupling the couplable and decouplable parts of the drive and/or load units.

### DETAILED DESCRIPTION OF THE DRAWINGS

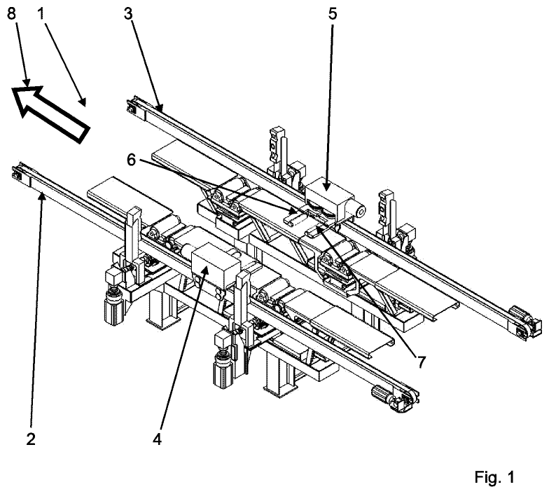

FIG. 1 shows a vehicle test stand 1. The travel direction in the forward direction of a vehicle located in the vehicle test stand 1 is identified by the arrow which is provided with the reference sign 8.

A vehicle conveyor system which will be explained hereunder can be seen.

The vehicle conveyor system has guiding elements 2 and 3 which are disposed laterally next to a section along which the vehicle is to be moved. These guiding elements can be conveyor belts.

The vehicle conveyor system furthermore has gripping elements 4 and 5.

In the context of the gripping element 5 it can be seen that two guiding means 6 and 7 are present. In the illustration of FIG. 1, these guiding means 6 and 7 are shown in a first position in which the guiding means 6 is in front of a wheel of the vehicle. The guiding means 7 is behind the wheel of the vehicle. Each of the guiding means 6 and 7 has a roller which in the first position shown in FIG. 1 rests on the respective wheel of the vehicle.

The guiding means 6 and 7 are pivotable to a second position which is not illustrated in more detail here. For this purpose, these guiding means 6 and 7 are in each case rotatable about a vertical axis by means of an activating unit. In this way, the guiding means 6 is pivotable toward the front in the travel direction of the vehicle and the guiding means 7 is pivotable toward the rear in the travel direction of the vehicle. These vertical axes herein are located in the region of the guiding element 3 so that the driving track of the wheel of the vehicle is free when the guiding means 6 and 7 are pivoted to the second position.

When the guiding elements 6 and 7 are in the first position, the wheel of the vehicle is gripped. When the gripping elements 4 and 5 are moved along the guiding elements 2 and 3, the vehicle is thus moved conjointly with the movement of the gripping elements 4 and 5. The movement of the gripping elements 4 and 5 along the guiding elements 2 and 3 takes place in a synchronized manner.

In the exemplary embodiment illustrated, the vehicle can be “placed” by the vehicle conveyor system in that the guiding means 6 and 7 are pivoted to the second position (i.e. the guiding means 6 and 7 are opened). The vehicle can be received by the vehicle conveyor system again when the guiding means 6 and 7 are pivoted to the first position so that the guiding means 6 and 7 are again located in front of (guiding means 6) and behind (guiding means 7) the respective wheel of the vehicle.

The wheel of the vehicle is moved so as to correspond to the movement of the gripping elements 4 and 5 when the guiding means 6 and 7 thereof are in the first position (and in the process encompass in each case one wheel of the vehicle). The wheel of the vehicle continues to bear on the floor of the workshop (or on the driving tracks of the vehicle test stand 1) and rolls thereon during the movement of the vehicle. For this purpose, the brakes of the vehicle are released, and the drive unit of the vehicle is disengaged and/or a transmission is in the idling position (manual transmission) or in the position “N” (automatic transmission), respectively.

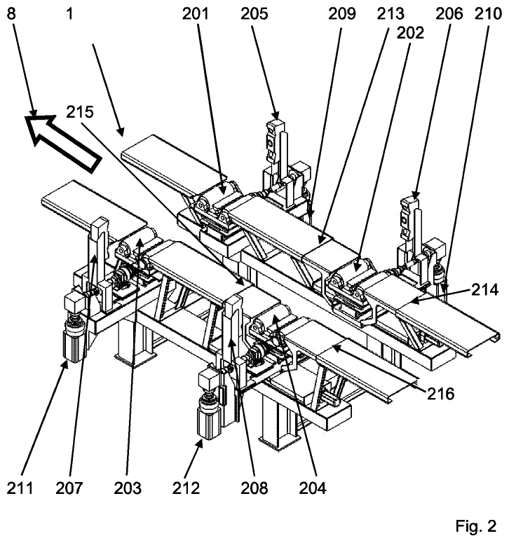

FIG. 2 shows the vehicle test stand 1 according to FIG. 1 without the vehicle conveyor system.

Four wheel receptacles 201, 202, 203 and 204 can be seen, one wheel of a vehicle to be tested bearing on each one of the former. It can be seen that the wheel receptacles have in each case double rollers so that the respectively bearing wheel of the vehicle drops between these two rollers of the respective wheel receptacle.

It can be seen that the wheel receptacles 202 and 204 are displaceable in relation to the wheel receptacles 201 and 203 in the direction of the arrow 8, or else counter to the direction of the arrow 8. Owing to this fact, the vehicle test stand 1 can be adjusted in such a way that vehicles which have different wheel bases can be tested on said vehicle test stand 1. Adapting to the track width of the vehicle can take place in that the length of the axles of the double rollers of the wheel receptacles is so large that the different track widths of different vehicles can be accommodated therewith. Optionally, the test stand can be adapted in this context in that the wheel receptacles 201 and 203, and 202 and 204, are displaceable relative to one another in the horizontal plane in a direction perpendicular to the direction of the arrow 8.

It is denoted in the illustration of FIG. 2 by the reference signs 213 and 214, and 215 and 216, that the length of the driving tracks for the vehicle in the vehicle test stand 1 for entering and exiting (or for the inward conveyance and outward conveyance, respectively) of the vehicle in terms of length change in the corresponding ranges so that continuous driving tracks are in each case present for the wheels of the vehicle.

It can moreover be seen in the illustration of FIG. 2 that measuring units 205, 206, 207 and 208 by way of which the parameters of the suspension geometry (toe angle, camber angle) of the respective wheels of the vehicle to be tested can be measured are present in the vehicle test stand 1. The measuring units can be designed, for example, as described in DE 10 2006 036 671 A1 or DE 10 2019 131 863 A1.

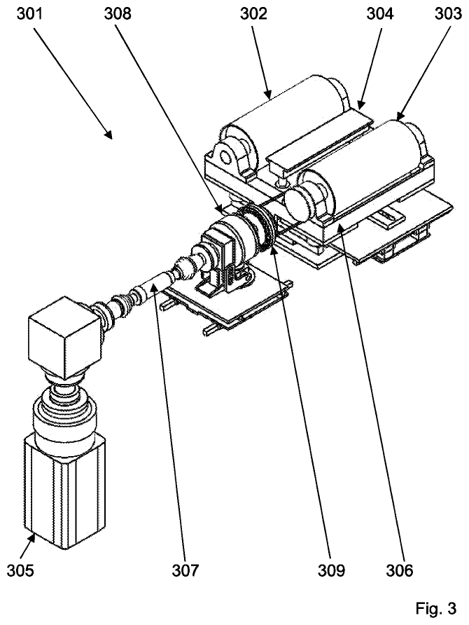

It can furthermore be seen that the individual wheel receptacles 201, 202, 203 and 204 are in each case assigned a drive and/or load unit 209, 210, 211 and 212 in such a manner that this drive and/or load unit 209, 210, 211 and 212 acts in each case on one of the two rollers of the wheel receptacles 201, 202, 203 and 204. The wheel receptacles 201, 202, 203, 204 with the load units 209, 210, 211 and 212 are described in more detail in FIGS. 3 to 5.

FIG. 3 shows of the wheel receptacles 201 to 204 which are illustrated in the vehicle test stand in FIG. 2. The wheel receptacle 301 has two rollers 302 and 303. In this way, the wheel receptacle 301 is a wheel receptacle with double rollers (302, 303).

A lifting bar 304 can be seen. When driving the vehicle out of the vehicle test stand, this lifting bar 304 is lifted. In this way, the corresponding wheel of the vehicle is lifted in such a way that this wheel is no longer dropped between the two rollers 302 and 303. Driving the vehicle out of the vehicle test stand is facilitated as a result.

Furthermore to be seen is a drive and/or load unit 305 which in the exemplary embodiment of the roller 303 illustrated here is assigned to the wheel receptacle 301.

The drive and/or load unit can have an electric motor by way of which the roller 303 of the wheel receptacle 301 can be driven or decelerated in relation to a rotation of the wheel bearing on the wheel receptacle 301. Alternatively or additionally to the electric motor, the drive and/or load unit can have a centrifugal mass by which the moment of inertia of the roller 303 is increased (in the case of drive and/or load unit 305 being coupled to the roller 303). In this way, driving resistances or a kinetic energy of the vehicle can be simulated, for example. The moment of inertia of the rollers 302 and 303 counteracts a change of the rotating speed of the bearing wheel by way of the frictional forces of the two rollers 302 and 303 in relation to the bearing wheel of the vehicle.

It can be seen that the two rollers 302 and 303 of the wheel receptacle 303 are disposed on a support device 306. This support device 306 is mounted in such a way that this support device 306 can be rotated about a vertical axis.

In a first operating state of the wheel receptacle 301, the support device 306 is freely rotatable in the sense that the rotation of the support device 306 follows the forces which are directed onto the rollers 302 and 303 of the wheel receptacle 301 by way of a change of the wheel axis of the bearing wheel of the vehicle.

There is furthermore a second operating state in which this support device can be rotated by driving means about the vertical axis in such a manner that by rotating the support device 306 in such a manner forces can be directed onto the bearing wheel of the vehicle owing to a change of the longitudinal axis of the rollers 302 and 303.

When the steering wheel of the vehicle is not fixedly held, the wheel axis of the bearing wheel in the process follows the rotation of the longitudinal axis of the rollers 302 and 303 during the rotation of the support device 306 about the vertical axis. Moreover, forces which act in the lateral direction are directed onto the wheel of the vehicle. As a result, the vehicle overall is positioned in the lateral direction on the rollers of the wheel receptacles. When the steering wheel of the vehicle is fixedly held, no rotation of the, only the positioning of the vehicle in the lateral direction on the rollers of the wheel receptacle, takes place.

It can be seen that the drive and/or load unit 305 is connected to the roller 303 by way of a homokinetic articulated shaft 307.

The drive and/or load unit 305 can be completely mechanically decoupled from the roller 303. The two Hirth serration elements 308 and 309 interact for this purpose. For mechanically coupling and decoupling, the Hirth serration element 308 for coupling can be moved toward the Hirth serration element 309 in such a way that these two Hirth serration elements 308 and 309 are in mutual engagement. For mechanically decoupling, the Hirth serration element 308 can be moved in the axial direction away from the Hirth serration element 309 in such a way that these two Hirth serration elements 308 and 309 are separated.

It can be seen that the drive and/or load unit 305 is not disposed on the support device 306. In the mechanically decoupled state of the drive and/or load unit 305 (the two Hirth serration elements 308 and 309 are in this instance separated, as illustrated in FIG. 3), the support device 306 with the rollers 302 and 303 disposed thereon, is rotatable about the vertical axis without having to conjointly rotate the drive and/or load unit 305 in the process. This likewise applies to the machine elements that are disposed between the drive and/or load unit 305 up to (and including) the Hirth serration element 308. Thus, this also relates to the homokinetic articulated shaft 307 and the driving means by way of which the Hirth serration element 308 is moved in order to bring the two Hirth serration elements 308 and 309 into engagement or to separate them.

The homokinetic articulated shaft 307 is variable in length to the extent that the former can compensate the change of the spacing between the drive and/or load unit 305 and the Hirth serration element 308 during coupling and decoupling.

Moreover, the homokinetic articulated shaft 307 can compensate changes of the orientation of the longitudinal axes of the Hirth serration elements 308 and 309 at least during the rotations of the support device about the vertical axis in the event of a coupled drive and/or load unit 305. This applies at least when these changes of the orientation take place only by way of minor angles.

When rotations of the support device 306 about the vertical axis are also be enabled about larger angles in the event of a decoupled drive and/or load unit 305, it is advantageous to movably mount the drive and/or load unit as well as the machine elements between the drive and/or load unit up to (and including) the Hirth serration element 308. This mobility can relate to a displacement in the horizontal plane in the direction of the arrow 8, as well as to a displacement perpendicular to the arrow 8. The drive and/or load unit 305 is particularly advantageously mounted in such a way that the latter is movable on a circular path of which the center is the intersection point between the horizontal plane and the vertical axis about which the support device 306 is rotatable. This rotatability means that the homokinetic articulated shaft 307 has to compensate only minor changes in orientation which are caused by the mechanical inertia by way of which the drive and/or load unit 305 follows a rotation of the support device 306.

In the first operating state of the wheel receptacle 301, the Hirth serration (308, 309) at the wheel receptacle is advantageously separated.

In the second operating state, the Hirth serration (308, 309) is advantageously mechanically coupled in order to carry out simulations of driving the vehicle.

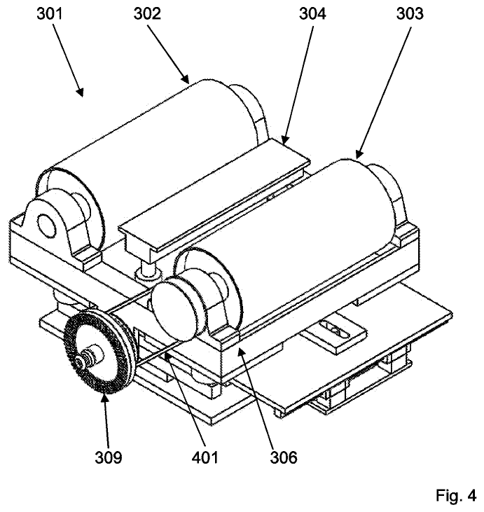

FIG. 4 shows the wheel receptacle 301 according to FIG. 3 without the drive and/or load unit. Components which are identical to those in FIG. 3 are provided with identical reference signs. It can be seen that the Hirth serration element 309 is connected to the roller 303 by way of a belt drive 401.

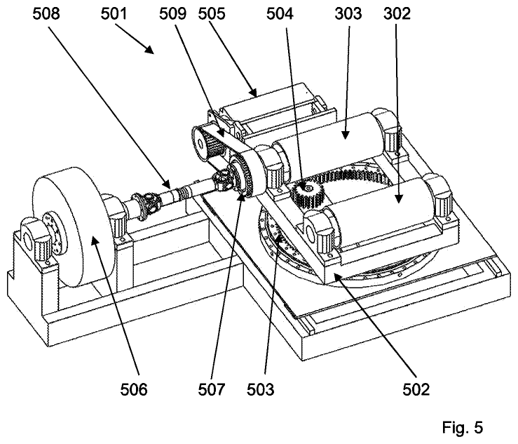

FIG. 5 shows a perspective view (top view) of a wheel receptacle 501 in which an exemplary embodiment of a rotation of the support device (support plate) 502 about a vertical axis is illustrated, wherein this rotation can be performed by a driving element. The driving element can be an electric motor. It can be seen in the illustration of FIG. 5 that the wheel receptacle has two rollers 302 and 303 and a ring gear 503 with an internal toothing. A gearwheel 504 by way of its toothing engages either permanently or releasably with the internal toothing of the ring gear 503.

The gearwheel 504 can be rotated by the driving element in such a way that said gearwheel 504 interacts with the ring gear 503 having the internal toothing, forming an epicyclic gear, when the toothing of the gearwheel 504 engages with the internal toothing of the ring gear 503.

The support device 502 is fastened to the ring gear 503 in such a way that the support device 502 is conjointly rotated with the ring gear 503 during a rotation of the ring gear 503.

It can be seen in the illustration of FIG. 5 that a combination of a drive unit 505 and a load unit 506 can be present as a drive and/or load unit.

The load unit 506 is a centrifugal mass for increasing the moment of inertia of the driven roller 303 when the load unit 506 is mechanically coupled. This mechanical coupling can be implemented by way of a Hirth serration 507. A homokinetic articulated shaft, which is a constituent part of the connection between the load unit 506 and the roller 303, is denoted by the reference sign 508. Optionally, a clutch can be additionally integrated in this connection, so that in the event of different rotating speeds of the roller 303 in terms of the rotation about the longitudinal axis of the latter and the rotation of the centrifugal mass the rotating speed of the centrifugal mass can be continuously adapted to the rotating speed of the roller 303 by slowly engaging the clutch.

In principle, it is possible to use two mutually corresponding clutch plates instead of the Hirth serration 507. In this case, the clutch plates are however designed to be open and without a surrounding housing to the extent that the described mechanical decoupling of the load unit 506 can be implemented by separating the two clutch plates when opening this clutch. In terms of the mechanical coupling and decoupling, this applies not only for the exemplary embodiment illustrated here but in principle also to other structural design embodiments of the wheel receptacle in conjunction with the respective drive and/or load unit. The difference between the Hirth serration 507 and the connection by way of the clutch plates lies in that the Hirth serration 507 is a form-fitting connection, while the connection by way of the two clutch plates is a force-fitting connection.

The load unit 506 and the connection of the load unit 506 to the roller 303 are not attached to the support device 502. In the first operating £ state of the wheel receptacle, this load unit 506 is mechanically decoupled. Owing to this fact, the moment of inertia of the wheel receptacle in terms of rotation about the vertical axis is reduced. As a result, the rollers 302, 302 of the wheel receptacle follow changes of the orientation of the wheel axis by way of high dynamics.

It can be seen that there is a drive unit 505 which by way of a belt drive 509 acts on the roller 303 so that the roller 303 by way of the drive unit 505 can be accelerated or decelerated in relation to the rotations of a bearing wheel. The belt drive 509 engages on the roller 303 in such a manner that this belt drive 509 remains operatively connected to the roller 303 even when the Hirth serration 507 is opened.

It can be seen that the drive unit 505 and the belt drive 509 are likewise attached to the support device 502. On account of this fact, the drive unit 505 is rotated conjointly with the rollers of the wheel receptacle about the vertical axis also in the first operating state. Advantageously, the drive unit is therefore constructed in such a way that the weight and in particular also the moment of inertia thereof in terms of a rotation of the rollers of the wheel receptacle about the vertical axis remains as low as possible. This construction has the advantage that the drive unit 505 remains mechanically coupled to the roller 303. For the rotation of the rollers of the wheel receptacle about the vertical axis, thus only the load unit is mechanically decoupled in this design embodiment.

For separating the drive train, there can optionally also be a clutch present in addition to this drive unit 505. If the drive unit 505 is an electric motor, the latter can be switched off in terms of current and voltage. If the wheel, apart from a change of the orientation of the wheel axis during the adjustment work, is also additionally imparted a rotation about the wheel axis, the two rollers 302 and 303 are correspondingly freely rotating. As a result, stresses in the suspension are largely avoided.

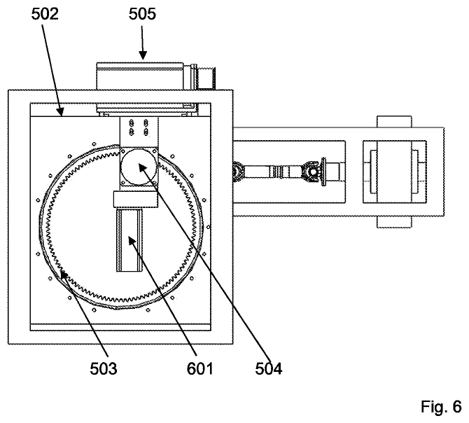

FIG. 6 shows a view of the wheel receptacle 501 from FIG. 5 from below. The driving element 601 by way of which the gearwheel 504 is able to be driven can be seen.

It can in particular be derived from the illustration in FIG. 6 that the drive unit 505 is attached to the support device 502.

In the second operating state of the wheel receptacle, the driving element 601 and the epicyclic gear (gearwheel 504 and internal toothing of the ring gear 503) are in an operating state in which the support device 502 is rotatable about the vertical axis by way of the driving element 601.

In the first operating state, the gearwheel 504 of the epicyclic gear can be separated from the internal toothing of the ring gear 503 to the extent that the support device 502 can freely rotate owing to forces which are transmitted from the wheel of the vehicle to the rollers of the wheel receptacle, without this being decelerated by the driving element 601. As a result of this mechanical separation of the gearwheel 504 of the epicyclic gear from the internal toothing of the ring gear 503, the rotating parts of the drive of the support device 502 are mechanically decoupled for the (driven) rotation about the vertical axis. In this context, the rotating parts of the drive are the gearwheel 504 of the epicyclic gear and the rotor of the driving element 601 and the (rotating) connection between the driving element 601 and the gearwheel 504 of the epicyclic gear. The inert masses, and thus also the moments of inertia, for the rotation of the support device 502 about the vertical axis owing to forces which are transmitted from the respective wheel of the vehicle to the rollers of the wheel receptacle are advantageously minimized as a result. In order to be able to perform the driven rotation of the support device 502 about the vertical axis, caused by the driving element 601, the driving element 601 is not attached to the support device 502.

As an alternative to this design embodiment (mechanical separation of the gearwheel 504 from the internal toothing of the ring gear 503) for the first operating state, it is also possible to switch off the driving element 601 in terms of current and voltage. The rotating parts of the drive (rotor of the driving element 601, gearwheel 504 of the epicyclic gear, and the connection between the driving element 601 and the gearwheel 504 of the epicyclic gear) then remain mechanically coupled and are rotated conjointly in a rotation of the support device 502, owing to forces which are directed from the respective wheel of the vehicle into the rollers of the wheel receptacles.

It is obvious that the force transmission from the driving element 601 for rotating the support device 502 does not mandatorily have to be implemented by way of an epicyclic gear. The first operating state of the wheel receptacles differs from the second operating state in that there is no force-fitting and/or form-fitting connection between the driving element 601 and the support device 502 in the first operating state, whereas in the second operating state a force-fitting and/or form-fitting connection exists between the driving element 601 and the support device 502, so that the support device 502 is rotatable about the vertical axis by means of the driving element 601.

The corresponding components of the drive are advantageously mechanically decoupled from the support device in the first operating state, so that the inert masses and moments of inertia for the rotation of the support device 502 about the vertical axis are minimized in the first operating state.

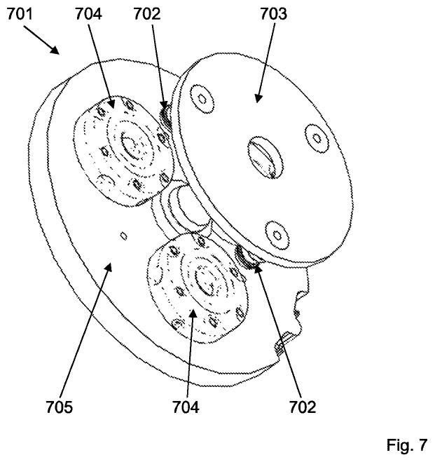

FIG. 7 shows an alternative construction for mechanically coupling and decoupling the couplable and decouplable parts of the drive and/or load units.

The mechanical coupling and decoupling of the couplable and decouplable parts can be performed in the following manner, for example:
force-fitting connection:
   clutch plates without clutch housing corresponding to the explanations in the context of FIG. 5;
   gripping elements which encompass a disk in a force-fitting manner corresponding to the functional mode of a chuck with clamping jaws (known from machine tools such as lathes, wood turning lathes, or else as chucks of drills);
form-fitting connection:
   Hirth serration;
   tension system in which gripping elements engage in mating gripping mounts in which the gripping elements are held in a form-fitting manner.

FIG. 7 shows a tension system 701 in which gripping elements 702 are disposed on a plate 703 in such a way that these gripping elements 702 are pushed into mating gripping mounts 704 which are disposed on a plate 705, when the plates 703 and 705 are converged (and in the process are correctly positioned relative to one another with a view to a rotation about the perpendicular bisector of the plates 703 and 705).

The mating gripping mounts 704 advantageously also have closing elements which, in the closed state thereof, hold the gripping elements 702 in a form-fitting manner in the respective mating gripping mount 704. The direction of movement of the closing elements here is advantageously oriented perpendicularly to the direction of movement of the gripping elements 702 when engaging in the respective gripping element 704, or when disengaging from the respective gripping element 704.

One of the two plates 703 or 705 in the context of examples disclosed herein is attached to that roller of the wheel receptacle on which the drive and/or load units are to act. The other of the two plates 705 or 703 represents the termination of the connection of the couplable and decouplable parts of the drive and/or load devices to this roller of the wheel receptacle.

In the illustrated exemplary embodiment of FIG. 7, three gripping elements 702 and three mating gripping elements 704 are provided. Any other number of gripping elements 702, and correspondingly also of mating gripping elements 704, can also be provided. It is only relevant that the gripping elements 702 and the mating gripping elements 704 when interacting have the effect of a form-fitting anti-rotation device of the two plates 703 and 705 relative to one another.

1. A vehicle test stand comprising wheel receptacles for the wheels of a vehicle to be tested,
wherein the wheel receptacles have in each case one support device to which are attached in each case one or two rollers on which the wheels of the vehicle to be tested bear;
wherein at least one of the rollers of a wheel receptacle is assigned a drive and/or load unit;
wherein in a first operating state of the wheel receptacles the respective support device is mounted so as to be rotatable about a vertical axis;
wherein, in this first operating state of the wheel receptacle, the support device is mounted so as to be freely rotating in such a way that the support device is rotatable due to forces that are transmitted from the bearing wheels of the vehicle to the rollers;
wherein
at least parts of the drive and/or load units can be mechanically coupled to and decoupled from the respective roller;
at least the couplable and decouplable parts of the drive and/or load units are not disposed on the respective support device;
wherein the connection of the couplable and decouplable parts of the drive and/or load units to the respective roller of the wheel receptacle during the mechanical coupling of the couplable and decouplable parts of the drive and/or load units to the respective roller is embodied in such a way that the connection follows a rotation of the longitudinal axis of the respective roller about the vertical axis;
and/or
wherein the drive and/or load units in the vehicle test stand are movable in the horizontal plane such that the longitudinal axis of the connection of the drive and/or load units to the respective roller follows the change of the orientation of the longitudinal axis of the respective roller during a rotation of the support device about the vertical axis.

2. The vehicle test stand as claimed defined in claim 1, wherein, in the first operating state of the wheel receptacle the couplable and decouplable parts of the respective drive and/or load unit are mechanically decoupled.

3. The vehicle test stand as claimed defined in claim 1, characterized in that wherein
in the second operating state of the wheel receptacles for carrying out driving simulations of the vehicle, the respective drive and/or load unit is mechanically coupled;
and
at best as a function of specific driving situations, the couplable and decouplable parts of the respective drive and/or load unit are completely mechanically decoupled.

4. The vehicle test stand as defined in claim 3, wherein, in the second operating state of the wheel receptacles, the support device is rotatable about at least one vertical axis by driving means in such a way that, owing to by the rotation of the respective support device, forces are transmitted via the at least one roller of the wheel receptacle to the bearing wheel of the vehicle to be tested.

5. The vehicle test stand as defined in claim 4, characterized in that wherein parts of the driving means in the first operating state of the wheel receptacle are mechanically decoupled from the support device.

6. The vehicle test stand as defined in one of claim 3, wherein, in the second operating state of the wheel receptacles, the couplable and decouplable parts of the drive and/or load units when carrying out driving simulations are mechanically decoupled at least when the specific driving situation consists of the vehicle being braked by a braking force that exceeds a defined threshold value.

7. The vehicle test stand as defined in one of claim 1, wherein a constituent part of the connection of the couplable and decouplable parts of the drive and/or load unit during the mechanical coupling of the couplable and decouplable parts of the drive and/or load units to the respective roller is a homokinetic articulated shaft.

8. The vehicle test stand as defined in one of claim 1, wherein the mechanical coupling and decoupling of the couplable and decouplable parts of the drive and/or load unit to and from the respective roller occurs via a coupling member, which includes a Hirth serration.

9. The vehicle test stand as defined in claim 1, wherein the vehicle test stand is assigned a vehicle conveyor system
for the automated inward conveyance of the vehicle into the vehicle test stand;
for placing the vehicle in such a manner that the wheels of the vehicle bear on the wheel receptacles of the vehicle test stand;
for receiving the vehicle by the vehicle conveyor system;
and
for the outward conveyance of the vehicle from the vehicle test stand.

10. A method for carrying out measurement and adjustment work on a vehicle, and for carrying out a vehicle test using a vehicle test stand as defined in claim, wherein 1, wherein in the case of a vehicle of which the wheels bear on the wheel receptacles of the vehicle test stand, the method comprising:
(i) carrying out measurement and adjustment work of parameters of the suspension geometry, wherein the respective wheel receptacles in the process are in the first operating state; and
(ii) simulating driving conditions for the vehicle to be tested, wherein the wheel receptacles in the process are in the second operating state.

11. The method as defined in claim 10
wherein
the wheel receptacles have in each case double rollers;
the wheel receptacles of the vehicle test stand have lifting means having a first operating position for lifting the wheels of the vehicle relative to a second operating position of the lifting means, in which the wheels of the vehicle are in the position dropped between the two rollers of the wheel receptacles when carrying out simulated driving of the vehicle;
and
receiving the vehicle by the vehicle conveyor system takes place to be synchronized with the adjustment of the lifting means to the first operating position of the latter.
